(19) United States
(12) Patent Application Publication
(10) Pub. No.: US 2019/0335395 A1
(43) Pub. Date: Oct. 31, 2019

(54) METHOD FOR CONTROLLING MOBILE TERMINAL, AND MOBILE TERMINAL

(71) Applicant: BEIJING KINGSOFT INTERNET SECURITY SOFTWARE CO., LTD., Beijing (CN)

(72) Inventor: Ruiqi Wang, Beijing (CN)

(73) Assignee: BEIJING KINGSOFT INTERNET SECURITY SOFTWARE CO., LTD., Beijing (CN)

(21) Appl. No.: 16/387,939

(22) Filed: Apr. 18, 2019

Related U.S. Application Data
(63) Continuation of application No. PCT/CN2017/106706, filed on Oct. 18, 2017.

(30) Foreign Application Priority Data
Oct. 24, 2016 (CN) 201610927666.0

(51) Int. Cl. H04W 52/02; H04M 1/22

(52) U.S. Cl. CPC H04W 52/027; H04M 2250/12; H04M 1/22

(57) ABSTRACT

A method for controlling a mobile terminal, a mobile terminal and a storage medium are provided. The method includes: when a mobile terminal is in a screen-on state, calculating an angle between a screen of the mobile terminal and the ground (S110); adjusting, according to the angle, screen luminance of the mobile terminal (S120).

### CROSS-REFERENCE TO RELATED APPLICATIONS

This application is a continuation application of International Application No. PCT/CN2017/106706, filed on Oct. 18, 2017, which claims priority to and benefits of Chinese Patent Application Serial No. 201610927666.0, filed with the State Intellectual Property Office of P. R. China on Oct. 24, 2016, and titled with “Method and device for controlling mobile terminal, and mobile terminal” by Beijing Kingsoft Security Software Co. LTD, the entire content of which is incorporated herein by reference.

### FIELD

The present disclosure relates to mobile terminal technology field, and more particularly, to a method and a device for controlling a mobile terminal and a mobile terminal.

### BACKGROUND

With the rapid development of mobile terminals and the continuous improvement of people's living standard, mobile terminals have become indispensable communication and entertainment tools in people's life. In People's Daily life, from personal entertainment to social activities, from morning to evening, from indoors to outdoors, people spend more and more time on mobile terminals every day, which makes the battery life of the mobile terminal a problem. In order to improve the battery life of the mobile terminal as much as possible, various application providers and mobile terminal manufacturers have also proposed an approach of adjusting screen luminance of the mobile terminal to achieve a power-saving effect.

In related technologies, the screen luminance of the mobile terminal is usually adjusted manually, or, a light sensor can be used to obtain a light intensity of ambient light and the screen luminance of the mobile terminal is adjusted according to the light intensity of ambient light. However, manual adjustment needs to utilize settings of the mobile terminal to control a progress bar of the screen luminance, for the user, the operation is complex; when the user no longer uses the mobile terminal and puts it on a desk, and the user is in an environment with stable ambient light, the screen luminance will not be adjusted according to the light intensity of ambient light, in this way, even though the user is not using the mobile terminal, the screen is in a screen-on state, resulting in rapid consumption of power of the mobile terminal and poor power-saving effect.

### SUMMARY

Embodiments of the present disclosure aim to solve at least one of the above technical problems at least to some extent.

Accordingly, a first objective of the present disclosure is to propose a method for controlling a mobile terminal.

A second objective of the present disclosure is to propose a mobile terminal.

A third objective of the present disclosure is to propose a storage medium.

In order to achieve the above objectives, embodiments of a first aspect of the present disclosure provide a method for controlling a mobile terminal, including: when a mobile terminal is in a screen-on state, calculating an angle between a screen of the mobile terminal and the ground; adjusting, according to the angle, screen luminance of the mobile terminal.

In order to achieve the above objectives, embodiments of a second aspect of the present disclosure provide a mobile terminal, includes: a housing, a processor, a memory, a circuit board and a power supply circuit, in which, the circuit board is disposed inside a space enclosed by the housing, the processor and the memory are positioned on the circuit board; the power supply circuit is configured to provide power for respective circuits or components of the mobile terminal; the memory is configured to store executable program codes; the processor is configured to run a program corresponding to the executable program codes by reading the executable program codes stored in the memory, to perform following steps: when the mobile terminal is in a screen-on state, calculating an angle between a screen of the mobile terminal and the ground; adjusting, according to the angle, screen luminance of the mobile terminal.

In order to achieve the above objectives, embodiments of a third aspect of the present disclosure provide a storage medium, configured to store application programs that, when executed, perform the method for controlling a mobile terminal of embodiments of the first aspect of the present disclosure.

The additional aspects and advantages of the present disclosure will be given in part in the description below and will become apparent in part from the following descriptions or from the practice of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a method for controlling a mobile terminal according to an embodiment of the present disclosure.

FIG. 2 is a schematic diagram of a gravity sensing coordinate in a mobile terminal according to an embodiment of the present disclosure.

FIG. 3 is a flow chart of a method for controlling a mobile terminal according to a specific embodiment of the present disclosure.

FIG. 4 is a block diagram of a device for controlling a mobile terminal according to an embodiment of the present disclosure.

FIG. 5 is a block diagram of a device for controlling a mobile terminal according to a specific embodiment of the present disclosure.

FIG. 6 is a block diagram of a device for controlling a mobile terminal according to another specific embodiment of the present disclosure.

FIG. 7 is a block diagram of a device for controlling a mobile terminal according to another specific embodiment of the present disclosure.

FIG. 8 is a block diagram of a mobile terminal according to an embodiment of the present disclosure.

### DETAILED DESCRIPTION

Reference will be made in detail to embodiments of the present disclosure. Embodiments of the present disclosure will be shown in drawings, in which the same or similar elements and the elements having same or similar functions are denoted by like reference numerals throughout the descriptions. The embodiments described herein according to drawings are explanatory and aiming at explaining the present disclosure, and cannot be construed to limit the present disclosure.

A method and a device for controlling a mobile terminal and a mobile terminal according to embodiments of the present disclosure will be described in detail below with reference to the accompanying drawings.

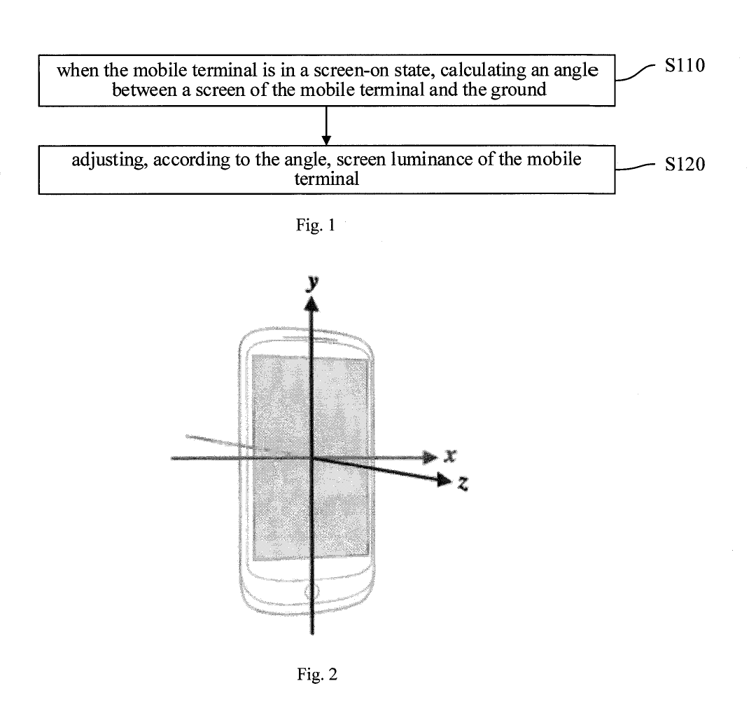

FIG. 1 is a flow chart of a method for controlling a mobile terminal according to an embodiment of the present disclosure. It should be noted that, the method for controlling a mobile terminal of embodiments of the present disclosure can be applied to the device for controlling a mobile terminal of embodiments of the present disclosure, the device for controlling a mobile terminal can be configured in a mobile terminal. The mobile terminal can be a hardware device with an operating system, such as a mobile phone, a tablet, a palmtop, a personal digital assistant, and the like.

As shown in FIG. 1, the method for controlling a mobile terminal may include the followings.

At block S110, when the mobile terminal is in a screen-on state, an angle between a screen of the mobile terminal and the ground is calculated.

Specifically, it may be detected whether the mobile terminal is currently in the screen-on state, if the mobile terminal is detected to be in the screen-on state, it may be determined whether a user of the mobile terminal is using the mobile terminal. It can be understood that, when the user is using the mobile terminal, the screen of the mobile terminal generally forms a parallel angle with his face, while the screen of the mobile terminal generally forms a 90 degree angle with the ground. Therefore, by utilizing this feature, the method for controlling a mobile terminal of embodiments of the present disclosure can judge whether the user is using the mobile terminal by judging the angle between the screen of the mobile terminal and the ground.

In particular, in an embodiment of the present disclosure, the angle between the screen of the mobile terminal and the ground can be calculated by the following steps: detecting a gravity sensing coordinate parameter of the mobile terminal through a gravity measuring device in the mobile terminal and calculating the angle between the screen of the mobile terminal and the ground according to the gravity sensing coordinate parameter of the mobile terminal. In an embodiment of the present disclosure, the gravity measuring device may be a gravity sensor, or other measuring devices that can be configured to measure the angle between the mobile terminal and the ground, such as a gyroscope and the like.

It can be understood that, the gravity sensing coordinate refers to a coordinate relative to the mobile terminal, rather than a spatial coordinate. For example, as shown in FIG. 2, when the mobile terminal is placed in a default direction, the X-axis is pointing horizontally to the right, the Y-axis is pointing vertically upward, and the z-axis is pointing away from the front of the screen, that is, the back of the screen corresponds to the negative value of Z. When the mobile terminal moves or rotates, these axes do not change, that is, they follow the mobile terminal. In other words, the gravity sensing coordinate system follows a natural direction of the mobile terminal.

More specifically, when it is detected that the mobile terminal is currently in the screen-on state, the gravity measuring device is activated, and the gravity sensing coordinate parameter (for example, the X-axis value, Y-axis value and z-axis value of the gravity-sensing coordinate system) of the mobile terminal is detected through the gravity measuring device, then, the angle between the screen of the mobile terminal and the ground is calculated according to the gravity sensing coordinate parameter of the mobile terminal. It can be understood that, since the Y-axis in the gravity sensing coordinate system represents the screen direction of the mobile terminal, the Y-axis value in the gravity sensing coordinate system can be obtained, which represents the angle between the screen of the mobile terminal and the ground.

At block S120, the screen luminance of the mobile terminal is adjusted according to the angle.

Specifically, after obtaining the angle between the screen of the mobile terminal and the ground, the screen luminance of the mobile terminal can be adjusted according to the angle.

It can be understood that, there are many ways to adjust the screen luminance of the mobile terminal according to the angle, for example, by presetting two thresholds according to experience, and adjusting the screen luminance accordingly when the angle is judged to be a preset threshold; for another example, by adjusting the screen luminance of the mobile terminal in real time according to different angles, the following two examples are shown to illustrate the process of these two ways.

As an example, when the angle is equal to a first threshold, the screen luminance of the mobile terminal is controlled to be reduced to a first luminance; when the angle is equal to a second threshold, the screen luminance of the mobile terminal is controlled to be increased to a second luminance, in which the first threshold is less than the second threshold, and the first luminance is less than the second luminance; when the angle is larger than the first threshold and smaller than the second threshold, a screen luminance value of the mobile terminal when the screen luminance was last adjusted is determined, and the screen luminance of the mobile terminal is controlled to be maintained at the screen luminance value. In embodiments of the present disclosure, the first threshold is 0 degrees, and a value range of the second threshold is from 45 to 90 degrees.

It can be understood that, when the angle between the screen of the mobile terminal and the ground is 0 degrees, it can be considered that the user is no longer using the mobile terminal, and when the angle between the screen of the mobile terminal and the ground is in 45˜90 degrees, it can be considered that the user is using the mobile terminal. Based on the above characteristics, the first threshold and the second threshold are set, and the first threshold is set to 0 degrees, and the value range of the second threshold is set to 45˜90 degrees respectively. In this way, the current angle between the screen of the mobile terminal and the ground is matched with the first and second thresholds, if the match is successful, the screen luminance of the mobile terminal is adjusted according to the matching result. For example, when the angle is equal to 0 degrees, the screen luminance is reduced to dim the screen; when the angle is in a range of 45 to 90 degrees, the screen luminance is increased; when the angle is greater than 0 degrees and less than 45 degrees, the screen brightness value of the mobile terminal in the last adjustment of screen luminance is determined, then the screen luminance is controlled to be maintained at the screen luminance value.

As another example, the screen luminance of a mobile terminal can be adjusted in real time according to the angle, for example, by presetting multiple angle intervals each corresponding to a distinct luminance level, and adjusting the screen luminance correspondingly according to the interval of the current angle, so as to achieve a real-time adjustment. The specific implementation can be referred to the specific description of the subsequent embodiments.

According to the method for controlling a mobile terminal of embodiments of the present disclosure, when the mobile terminal is in the screen-on state, the angle between the screen of the mobile terminal and the ground is calculated and the screen luminance of the mobile terminal is adjusted according to the angle, such that in the process of adjusting the screen luminance, no manual adjustment by a user is required, thus simplifying user's operation. In addition, since the angle between the screen of the mobile terminal and the ground can perfectly reflect whether the user is using the mobile terminal, the screen luminance is directly adjusted in accordance with the angle between the screen of the mobile terminal and the ground, thereby avoiding the situation that the screen is in a highly lit screen state while the user is not using the mobile terminal, saving power of the mobile terminal, and improving power-saving effect.

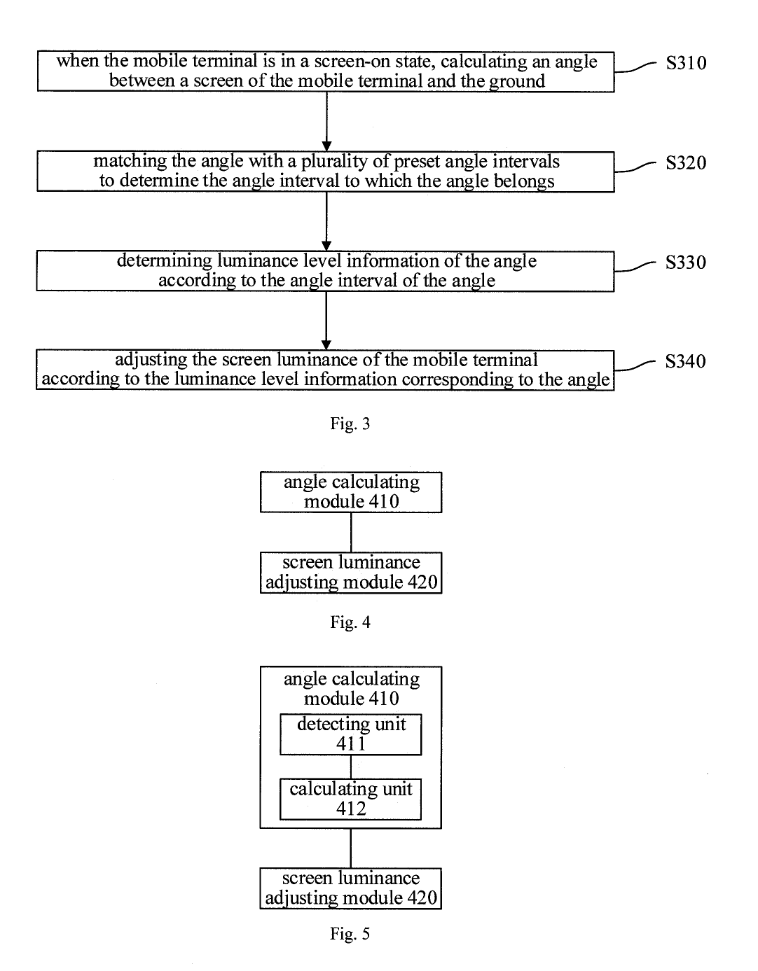

FIG. 3 is a flow chart of a method for controlling a mobile terminal according to a specific embodiment of the present disclosure.

In order to further improve availability and feasibility, and to improve power-saving effect, in embodiments of the present disclosure, the screen luminance of the mobile terminal can be adjusted in real time according to different angles, for example, by presetting multiple angle intervals each corresponding to a distinct luminance level and adjusting the screen luminance correspondingly according to the interval of the current angle, so as to achieve a real-time adjustment. Specifically, as shown in FIG. 3, the method of controlling the mobile terminal can include the followings.

At block S310, when a mobile terminal is in a screen-on state, an angle between a screen of the mobile terminal and the ground is calculated.

At block S320, the angle is to be matched with multiple preset angle intervals to determine an angle interval to which the angle belongs.

It can be understood that, in embodiments of the present disclosure, multiple angle intervals are preset, for example, four angle intervals can be set: [0,25), [25,50), [50,75), and [75,90], and each angle interval corresponds to a luminance level. In this way, after obtaining the angle between the screen of the mobile terminal and the ground, the angle is to be matched with the preset angle intervals to determine the angle interval in which the angle falls.

At block S330, luminance level information of the angle is determined according to the angle interval of the angle.

Specifically, after determining the angle interval to which the angle belongs, the luminance level information corresponding to the angle between the screen of the mobile terminal and the ground can be determined according to the angle interval to which the angle belongs. For example, assuming that the angle interval of the angle is [25,50), its corresponding luminance level information can be 40%; when the angle interval of the angle is [0,25), its corresponding luminance level information can be 20%, and so on. It can be understood that, the above luminance level information expressed as a percentage is only an example and should not be considered to be a limit to the present disclosure. The luminance level information can also be expressed in other forms.

At block S340, the screen luminance of the mobile terminal is adjusted according to the luminance level information corresponding to the angle.

According to the method for controlling a mobile terminal of embodiments of the present disclosure, the screen luminance of a mobile terminal can be adjusted in real time according to different angles, for example, by presetting multiple angle intervals each corresponding to a distinct luminance level and adjusting the screen luminance correspondingly according to the interval of the current angle, so as to achieve a real-time adjustment, which improves the availability and feasibility of the present disclosure as well as the power-saving effect.

In order to further improve the power-saving effect and improve user experience, optionally, in an embodiment of the present disclosure, while adjusting the screen luminance of the mobile terminal according to the angle, the method for controlling a mobile terminal may also include: adjusting a working mode of the mobile terminal according to the angle, in which the working mode at least includes a power-saving mode and a standard mode. In embodiments of the present disclosure, when the angle is equal to the first threshold, the mobile terminal is controlled to switch to the power-saving mode; when the angle is equal to the second threshold, the mobile terminal is controlled to switch to the standard mode.

It can be understood that, the above power-saving mode can include turning off the Bluetooth function of the mobile terminal, turning off applications consuming high traffic in the background, and turning off the WiFi (Wireless Fidelity) function without hot spots, and the like. The above standard mode can be understood as the working mode in which a user can use the mobile terminal normally, for example, the user can normally use Bluetooth, WiFi functions and so on.

For instance, the method for controlling a mobile terminal of embodiments of the present disclosure can be applied to an optimization scenario of applications in a mobile terminal, that is, it is assumed that an application may be running normally while the mobile terminal is in a screen-on state, in this case, when the user simply waits for the application to run and nothing else is done on the mobile terminal, the user may place the mobile terminal on the desk to wait for an accomplishment of running of the application, in this way, the application can be optimized through the present disclosure to reduce the power consumption of the mobile terminal.

Corresponding to the method for controlling a mobile terminal provided by the above embodiments, an embodiment of the present disclosure also provides a device for controlling a mobile terminal. Since the device for controlling a mobile terminal provided by embodiments of the present disclosure corresponds to the method for controlling a mobile terminal provided by the above embodiments, the aforementioned implementation of the method for controlling a mobile terminal is also applicable to the device for controlling a mobile terminal provided by this embodiment, which will not be described in detail in this embodiment. FIG. 4 is a block diagram of a device for controlling a mobile terminal according to an embodiment of the present disclosure. As shown in FIG. 4, the device for controlling a mobile terminal can include: an angle calculating module 410 and a screen luminance adjusting module 420.

Specifically, the angle calculating module 410 can be configured to calculate an angle between a screen of the mobile terminal and the ground when the mobile terminal is in a screen-on state. As an example, as shown in FIG. 5, the angle calculating module 410 may include: a detecting unit 411 and a calculating unit 412. The detecting unit 411 is configured to detect a gravity sensing coordinate parameter of the mobile terminal through a gravity measuring device in the mobile terminal. The calculating unit 412 is configured to calculate the angle between the screen of the mobile terminal and the ground according to the gravity sensing coordinate parameter of the mobile terminal.

The screen luminance adjusting module 420 is configured to adjust, according to the angle, screen luminance of the mobile terminal.

As an example, the specific implementation of adjusting by the screen luminance adjusting module 420 according to the angle, the screen luminance of the mobile terminal, can be as follows: when the angle is equal to a first threshold, the screen luminance of the mobile terminal is controlled to be reduced to a first luminance; when the angle is equal to a second threshold, the screen luminance of the mobile terminal is controlled to be increased to a second luminance, in which the first threshold is less than the second threshold, and the first luminance is less than the second luminance; when the angle is larger than the first threshold and smaller than the second threshold, a screen luminance value of the mobile terminal when the screen luminance was last adjusted is determined, and the screen luminance of the mobile terminal is controlled to be maintained at the screen luminance value. In embodiments of the present disclosure, the first threshold is 0 degrees, and a value range of the second threshold is from 45 to 90 degrees.

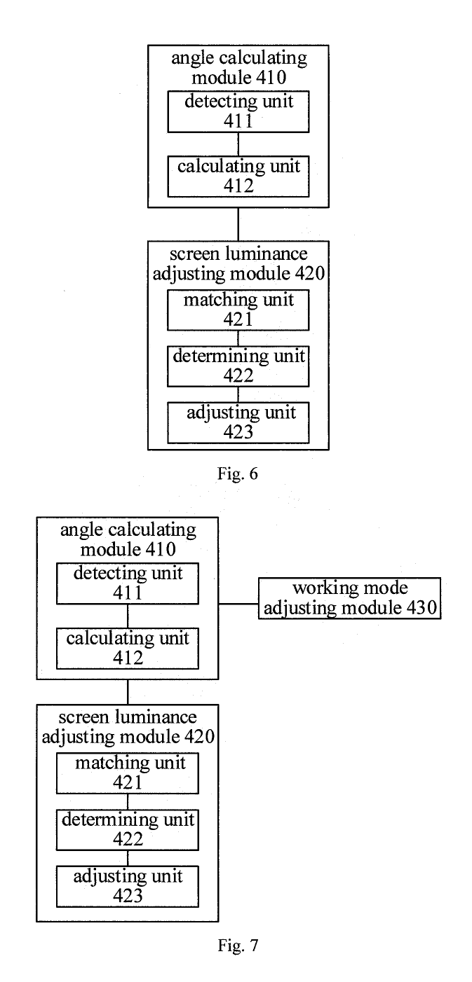

As another example, as shown in FIG. 6, the screen luminance adjusting module 420 may include: a matching unit 421, a determining unit 422 and an adjusting unit 423. The matching unit 421 is configured to match the angle with a plurality of preset angle intervals to determine an angle interval to which the angle belongs. The determining unit 422 is configured to determine luminance level information corresponding to the angle according to the angle interval to which the angle belongs. The adjusting unit 423 is configured to adjust the screen luminance of the mobile terminal according to the luminance level information corresponding to the angle.

Optionally, in an embodiment of the present disclosure, as shown in FIG. 7, the device for controlling a mobile terminal may also include: a working mode adjusting module 430. The working mode adjusting module 430 is configured to adjust a working mode of the mobile terminal according to the angle while the screen luminance adjusting module adjusts the screen luminance of the mobile terminal according to the angle, in which the working mode at least includes a power-saving mode and a standard mode.

In embodiments of the present disclosure, when the angle is equal to the first threshold, the working mode adjusting module 430 controls the mobile terminal to switch to the power-saving mode; when the angle is equal to the second threshold, the working mode adjusting module 430 controls the mobile terminal to switch to the standard mode.

According to the device for controlling a mobile terminal of embodiments of the present disclosure, when the mobile terminal is in the screen-on state, the angle between the screen of the mobile terminal and the ground is calculated by the angle calculating module and the screen luminance of the mobile terminal is adjusted by the screen luminance adjusting module according to the angle, such that in the process of adjusting the screen luminance, no manual adjustment by a user is required, thus simplifying user's operation; in addition, since the angle between the screen of the mobile terminal and the ground can perfectly reflect whether the user is using the mobile terminal, the screen luminance is directly adjusted in accordance with the angle between the screen of the mobile terminal and the ground, thereby avoiding a situation that the screen is in a screen-on state with high luminance while the user is not using the mobile terminal, saving power of the mobile terminal, and improving power-saving effect.

In order to realize the above embodiments, the present disclosure also provides a mobile terminal.

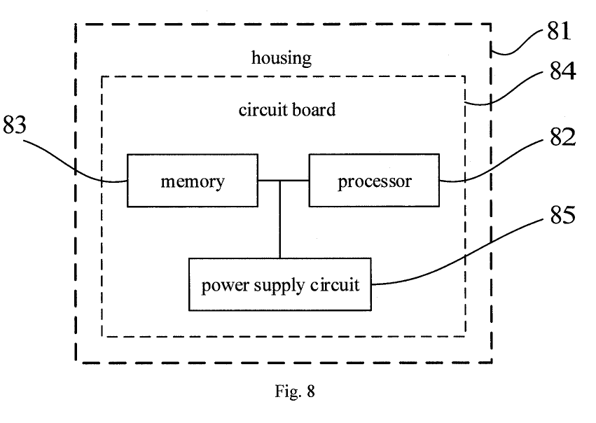

FIG. 8 is a block diagram of a mobile terminal according to an embodiment of the present disclosure. As shown in FIG. 8, the mobile terminal may include: a housing 81, a processor 82, a memory 83, a circuit board 84 and a power supply circuit 85. The circuit board 84 is disposed inside a space enclosed by the housing 81, the processor 82 and the memory 83 are positioned on the circuit board 84; the power supply circuit 85 is configured to provide power for respective circuits or components of the mobile terminal; the memory 83 is configured to store executable program codes; the processor 82 is configured to run a program corresponding to the executable program codes by reading the executable program codes stored in the memory 83, to perform following steps.

At block S110′, when the mobile terminal is in a screen-on state, an angle between a screen of the mobile terminal and the ground is calculated.

At block S120′, screen luminance of the mobile terminal is adjusted according to the angle.

According to the mobile terminal of embodiments of the present disclosure, when the mobile terminal is in the screen-on state, the angle between the screen of the mobile terminal and the ground is calculated and the screen luminance of the mobile terminal is adjusted according to the angle, such that in the process of adjusting the screen luminance, no manual adjustment by a user is required, thus simplifying user's operation; in addition, since the angle between the screen of the mobile terminal and the ground can perfectly reflect whether the user is using the mobile terminal, the screen luminance is directly adjusted in accordance with the angle between the screen of the mobile terminal and the ground, thereby avoiding a situation that the screen is in a screen-on state with high luminance while the user is not using the mobile terminal, saving power of the mobile terminal, and improving power-saving effect.

In addition, the present disclosure also proposes a storage medium, configured to store application programs that, when executed, implement the method for controlling a mobile terminal according to any one of above embodiments.

In addition, terms such as “first” and “second” are used herein for purposes of description and are not intended to indicate or imply relative importance or significance. Thus, the feature defined with “first” and “second” may comprise one or more this feature. In the description of the present disclosure, “a plurality of” means at least two, for example, two or three, unless specified otherwise.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be completed.

In addition, individual functional units in the embodiments of the present disclosure may be integrated in one processing module or may be separately physically present, or two or more units may be integrated in one module. The integrated module as described above may be achieved in the form of hardware, or may be achieved in the form of a software functional module. If the integrated module is achieved in the form of a software functional module and sold or used as a separate product, the integrated module may also be stored in a computer readable storage medium.

The storage medium mentioned above may be read-only memories, magnetic disks or CD, etc. Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A method for controlling a mobile terminal, comprises:
when the mobile terminal is in a screen-on state, calculating an angle between a screen of the mobile terminal and the ground; and
adjusting, according to the angle, screen luminance of the mobile terminal comprising:
when the angle is equal to a first threshold, controlling the screen luminance of the mobile terminal to be reduced to a first luminance;
when the angle is equal to a second threshold, controlling the screen luminance of the mobile terminal to be increased to a second luminance, wherein, the first threshold is less than the second threshold, and the first luminance is less than the second luminance; and
when the angle is larger than the first threshold and smaller than the second threshold, determining a screen luminance value of the mobile terminal when the screen luminance was last adjusted, and controlling the screen luminance of the mobile terminal to be maintained at the screen luminance value.

2. The method according to claim 1, wherein, the step of calculating the angle between the screen of the mobile terminal and the ground, comprises:
detecting a gravity sensing coordinate parameter of the mobile terminal through a gravity measuring device in the mobile terminal; and
calculating the angle between the screen of the mobile terminal and the ground according to the gravity sensing coordinate parameter of the mobile terminal.

3. The method according to claim 1, wherein, the first threshold is 0 degrees, and a value range of the second threshold is from 45 to 90 degrees.

4. The method according to claim 1, wherein, the step of adjusting, according to the angle, the screen luminance of the mobile terminal, comprises:
matching the angle with a plurality of preset angle intervals to determine an angle interval to which the angle belongs;
determining luminance level information corresponding to the angle according to the angle interval to which the angle belongs; and
adjusting the screen luminance of the mobile terminal according to the luminance level information corresponding to the angle.

5. The method according to claim 1, wherein, when adjusting, according to the angle, the screen luminance of the mobile terminal, the method further comprises:
adjusting a working mode of the mobile terminal according to the angle, wherein, the working mode at least includes a power-saving mode and a standard mode;
wherein, when the angle is equal to the first threshold, the mobile terminal is controlled to switch to the power-saving mode; when the angle is equal to the second threshold, the mobile terminal is controlled to switch to the standard mode.

6. A mobile terminal, comprises:
a housing, a processor, a memory, a circuit board and a power supply circuit, wherein, the circuit board is disposed inside a space enclosed by the housing, the processor and the memory are positioned on the circuit board; the power supply circuit is configured to provide power for respective circuits or components of the mobile terminal; the memory is configured to store executable program codes; the processor is configured to run a program corresponding to the executable program codes by reading the executable program codes stored in the memory, to perform following steps: when the mobile terminal is in a screen-on state, calculating an angle between a screen of the mobile terminal and the ground; adjusting, according to the angle, screen luminance of the mobile terminal;
wherein the step of adjusting, according to the angle, the screen luminance of the mobile terminal, comprises: when the angle is equal to a first threshold, controlling the screen luminance of the mobile terminal to be reduced to a first luminance; when the angle is equal to a second threshold, controlling the screen luminance of the mobile terminal to be increased to a second luminance, wherein, the first threshold is less than the second threshold, and the first luminance is less than the second luminance; and when the angle is larger than the first threshold and smaller than the second threshold, determining a screen luminance value of the mobile terminal when the screen luminance was last adjusted, and controlling the screen luminance of the mobile terminal to be maintained at the screen luminance value.

7. The mobile terminal according to claim 6, wherein, the step of calculating the angle between the screen of the mobile terminal and the ground, comprises:
detecting a gravity sensing coordinate parameter of the mobile terminal through a gravity measuring device in the mobile terminal; and
calculating the angle between the screen of the mobile terminal and the ground according to the gravity sensing coordinate parameter of the mobile terminal.

8. The mobile terminal according to claim 6, wherein, the first threshold is 0 degrees, and a value range of the second threshold is from 45 to 90 degrees.

9. The mobile terminal according to claim 6, wherein, the step of adjusting, according to the angle, the screen luminance of the mobile terminal, comprises:
matching the angle with a plurality of preset angle intervals to determine an angle interval to which the angle belongs;
determining luminance level information corresponding to the angle according to the angle interval to which the angle belongs; and
adjusting the screen luminance of the mobile terminal according to the luminance level information corresponding to the angle.

10. The mobile terminal according to claim 6, wherein, when adjusting, according to the angle, the screen luminance of the mobile terminal, the method further comprises:
adjusting a working mode of the mobile terminal according to the angle, wherein, the working mode at least includes a power-saving mode and a standard mode;
wherein, when the angle is equal to the first threshold, the mobile terminal is controlled to switch to the power-saving mode; when the angle is equal to the second threshold, the mobile terminal is controlled to switch to the standard mode.

11. A storage medium, configured to store application programs that, when executed, implement the method for controlling a mobile terminal comprising:
when the mobile terminal is in a screen-on state, calculating an angle between a screen of the mobile terminal and the ground; and
adjusting, according to the angle, screen luminance of the mobile terminal comprising:
when the angle is equal to a first threshold, controlling the screen luminance of the mobile terminal to be reduced to a first luminance; when the angle is equal to a second threshold, controlling the screen luminance of the mobile terminal to be increased to a second luminance, wherein, the first threshold is less than the second threshold, and the first luminance is less than the second luminance; and when the angle is larger than the first threshold and smaller than the second threshold, determining a screen luminance value of the mobile terminal when the screen luminance was last adjusted, and controlling the screen luminance of the mobile terminal to be maintained at the screen luminance value.

12. The storage medium according to claim 11, wherein, the step of calculating the angle between the screen of the mobile terminal and the ground, comprises:
detecting a gravity sensing coordinate parameter of the mobile terminal through a gravity measuring device in the mobile terminal; and
calculating the angle between the screen of the mobile terminal and the ground according to the gravity sensing coordinate parameter of the mobile terminal.

13. The storage medium according to claim 11, wherein, the first threshold is 0 degrees, and a value range of the second threshold is from 45 to 90 degrees.

14. The storage medium according to claim 11, wherein, the step of adjusting, according to the angle, the screen luminance of the mobile terminal, comprises:
matching the angle with a plurality of preset angle intervals to determine an angle interval to which the angle belongs;
determining luminance level information corresponding to the angle according to the angle interval to which the angle belongs; and
adjusting the screen luminance of the mobile terminal according to the luminance level information corresponding to the angle.

15. The storage medium according to claim 11, wherein, when adjusting, according to the angle, the screen luminance of the mobile terminal, the method further comprises:
adjusting a working mode of the mobile terminal according to the angle, wherein, the working mode at least includes a power-saving mode and a standard mode;
wherein, when the angle is equal to the first threshold, the mobile terminal is controlled to switch to the power-saving mode; when the angle is equal to the second threshold, the mobile terminal is controlled to switch to the standard mode.
